(19) United States
(12) Patent Application Publication
(10) Pub. No.: US 2020/0271461 A1
(43) Pub. Date: Aug. 27, 2020

(54) INFORMATION PROCESSING APPARATUS, INFORMATION PROCESSING METHOD AND PROGRAM

(71) Applicant: TOYOTA JIDOSHA KABUSHIKI KAISHA, Toyota-shi (JP)

(72) Inventors: Keiji Yamashita, Nisshin-shi (JP); Hiromichi Dogishi, Nagoya-shi (JP); Masaki Shitara, Nagakute-shi (JP); Nozomi Kaneko, Nagoya-shi (JP); Naoki Yamamuro, Nagoya-shi (JP); Shunsuke Tanimori, Susono-shi (JP); Ryoichi Shiraishi, Anjo-shi (JP)

(73) Assignee: TOYOTA JIDOSHA KABUSHIKI KAISHA, Toyota-shi (JP)

(21) Appl. No.: 16/792,966

(22) Filed: Feb. 18, 2020

(30) Foreign Application Priority Data
Feb. 27, 2019 (JP) 2019-034608

(51) Int. Cl. G01C 21/34; G06Q 10/08; G06Q 10/06; G05D 1/00

(52) U.S. Cl. CPC G01C 21/3407; G06Q 10/0832; G05D 1/0088; G06Q 10/08355; G06Q 10/06315; G06Q 10/087

(57) ABSTRACT

An information processing apparatus executes setting a priority of a package, based on information on a user receiving the package and information on the package; and in a case where the desired delivery time of a first package among a plurality of packages is changed while the moving object is traveling based on an operation command, with the plurality of packages loaded, when it is not possible to deliver the first package at the changed desired delivery time unless a delivery time of another package than the first package is changed, changing the delivery time of a second package among the plurality of packages, and generating a renewed operation command such that the delivery time of the first package becomes closer to the changed desired delivery time. The second package has a lower priority than the first package.

### INCORPORATION BY REFERENCE

The disclosure of Japanese Patent Application No. 2019-034608 filed on Feb. 27, 2019 including the specification, drawings and abstract is incorporated herein by reference in its entirety.

### BACKGROUND

### 1. Technical Field

The present disclosure relates to an information processing apparatus, an information processing method, and a program.

### 2. Description of Related Art

A system for confirming whether delivery, by a moving object that autonomously travels, is available or not when a package is designated to be delivered by the moving object is widely known (see, for example, Japanese Unexamined Patent Application Publication No. 2018-124676).

### SUMMARY

There is a service for delivering packages during a period of time desired by a user. However, the waiting time of user may be increased since the period of time that the user can designate is set within a certain margin of time considering, for example, delivery delay. Furthermore, the user receiving the package may be absent at the delivery time that the user has designated because of a change in the user's schedule. Consequently, the package cannot be properly received, the user is inconvenienced and there are further costs due to redelivery. The present disclosure is intended to provide efficient delivery of packages.

One aspect of the present disclosure is an information processing apparatus that controls a moving object that delivers a package by autonomous travel. The information processing apparatus includes a control unit configured to execute: generating an operation command for the moving object based on a delivery destination and a desired delivery time of the package; setting a priority of the package, based on information on a user receiving the package or information on the package; and in a case where the desired delivery time of a first package among a plurality of packages is changed while the moving object is traveling based on the operation command, with the plurality of packages loaded, when it is not possible to deliver the first package at the changed desired delivery time unless a delivery time of another package than the first package is changed, changing the delivery time of a second package among the plurality of packages, and generating a renewed operation command such that the delivery time of the first package becomes closer to the changed desired delivery time. The second package has a lower priority than the first package.

Another aspect of the present disclosure is an information processing method of controlling a moving object that delivers a package by autonomous travel, which is executed by a computer. The information processing method includes the steps of: generating an operation command for the moving object based on a delivery destination and a desired delivery time of the package; setting a priority of the package, based on information on a user receiving the package or information on the package; and, in a case where the desired delivery time of a first package among a plurality of packages is changed while the moving object is traveling based on the operation command, with the plurality of packages loaded, when it is not possible to deliver the first package at the changed desired delivery time unless a delivery time of another package than the first package is changed, changing the delivery time of a second package among the plurality of packages, and generating a renewed operation command such that the delivery time of the first package becomes closer to the changed desired delivery time. The second package has a lower priority than the first package.

Yet another aspect of the present disclosure is a program that controls a moving object that delivers a package by autonomous travel. The program causes a computer to execute: generating an operation command for the moving object based on a delivery destination and a desired delivery time of the package; setting a priority of the package, based on information on a user receiving the package or information on the package; and, in a case where the desired delivery time of a first package among a plurality of packages is changed while the moving object is traveling based on the operation command, with the plurality of packages loaded, when it is not possible to deliver the first package at the changed desired delivery time unless a delivery time of another package than the first package is changed, changing the delivery time of a second package among the plurality of packages, and generating a renewed operation command such that the delivery time of the first package becomes closer to the changed desired delivery time. The second package has a lower priority than the first package.

According to the present disclosure, it is possible to provide efficient delivery of packages.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a schematic configuration example of a delivery system according to an embodiment of the present disclosure;

FIG. 2 is a diagram illustrating a travel route of a vehicle;

FIG. 3 is a diagram illustrating a travel route of the vehicle;

FIG. 4 is a block diagram schematically illustrating each exemplified configuration of the vehicle, a first user terminal, a second user terminal, and a server, which constitute the delivery system according to the embodiment;

FIG. 5 is a diagram illustrating one example of a functional configuration of the server;

FIG. 6 is a diagram illustrating a table configuration of vehicle information;

FIG. 7 is a diagram illustrating a table configuration of user information;

FIG. 8 is a diagram illustrating a table configuration of package information;

FIG. 9 is a diagram illustrating one example of a functional configuration of the vehicle;

FIG. 10 is a diagram illustrating a functional configuration of a user terminal;

FIG. 11 is a diagram illustrating a processing sequence of the delivery system;

FIG. 12 is an exemplified flowchart illustrating an operation command generation process according to the embodiment; and

FIG. 13 is an exemplified flowchart illustrating a renewed operation command generation process according to the embodiment.

### DETAILED DESCRIPTION OF EMBODIMENTS

A moving object controlled by an information processing apparatus, which is one of the aspects of the present disclosure, autonomously travels based on an operation command. The operation command is generated so that the moving object travels, via each transit point, to a delivery location of packages in order to deliver the packages. Further, the moving object may stop at the delivery location, whereby the user may directly receive the package from the moving object stopped at the delivery location or the package may be received by the user using equipment provided in the moving object.

The control unit generates the operation command for the moving object so that each package can be delivered to a delivery destination at a desired delivery time, based on the delivery destination and the desired delivery time of each package. The operation command is generated by, for example, a server or the moving object. The operation command includes, for example, information on transit points of the moving object and information on the order in which the moving object travels to the transit points, and may further include information on a travel route of the moving object. The moving object can deliver the package by traveling to the delivery location in accordance with the operation command. The delivery destination and the desired delivery time are designated by, for example, the user receiving the package. The desired delivery time may be set by the user selecting a time from a predetermined delivery time period or, alternatively, as a time designated by the user.

The user can change the desired delivery time even while the moving object is in service in accordance with the operation command. However, in a case where the delivery time of a first package is changed, the delivery time of other packages may be affected. When the delivery time of the first package is changed, the delivery time of a second package, of which a priority is lower than that of the first package, can be altered. That is, if the delivery time of the first package can be matched with the desired delivery time of a first user by changing the delivery time of the second package, that has a lower priority than the first package, the delivery time of the second package is changed such that the delivery time of the first package can be matched with the desired delivery time of the first user.

Accordingly, the control unit sets the priority for each package. This priority is a priority that allows the delivery time of the package to be close to the desired delivery time. The priority is related to the strength of the demand for the package to be delivered at the desired delivery time. The control unit generates the operation command so that the actual delivery time of the package with a higher priority is more accurately close to the desired delivery time. In other words, the actual delivery time of the package with a lower priority may deviate from the desired delivery time. The priority of the package is set based on the user information or the package information. By setting the priority based on the user information, it is possible to set the priority in accordance with the user. Furthermore, by setting the priority based on the package information, it is possible to set the priority according to the package. The control unit generates a renewed operation command so that the delivery time of the package with a higher priority is more accurately close to the desired delivery time. Consequently, since the package with a higher priority can be easily delivered at the desired delivery time, it is possible to deliver the package with a higher priority more reliably.

The user information on the user receiving the package may be information about an attribute of the user receiving the package. Further, the package information may be information on the delivery destination of the package, or information about an attribute of the package.

By acquiring the information on the user attribute, it is possible to set the priority in accordance with the user attribute. Furthermore, by acquiring the information on the delivery destination of the package, it is possible to set the priority in accordance with the delivery destination of the package. By acquiring the information on the package attribute, it is possible to set the priority in accordance with the package attribute. The information on the user attribute is related to, for example, information indicating how easily the package can be received. That is, by lowering the priority of a user who can easily receive a package and raising the priority of a user who cannot easily receive a package, the user who cannot easily receive a package is given a higher priority for the delivery time, so that packages can be received more easily. Furthermore, the information on the package attribute is related to information on the type of the package. For example, depending on the type of the package, it may be better to receive the package earlier. In such a case, a higher priority is allocated to allow the user to easily receive the package. How easily the package can be received is also determined according to the delivery destination. By allocating a higher priority to a location where it is difficult to receive a package, it is possible to prevent the package from not being received. For example, a higher priority is allocated to a location where traffic congestion is likely to occur since it is more difficult to receive a package.

Furthermore, the control unit may acquire information indicating whether the user is an individual or a corporation as the information on the user attribute of the user receiving the package, and may allocate a higher priority to the package when the user is an individual than when the user is a corporation.

In other words, when the user is a corporation, the package can be easily received since a plurality of people may be present at the delivery destination. Furthermore, since it is easy to secure a place for storing the package, it is possible to store lots of products and the like. Accordingly, a problem is unlikely to occur even if the delivery time slightly deviates from the desired delivery time. On the other hand, when a package should be delivered to a private home, the package cannot be received when the user is absent. Therefore, it is desirable to deliver the package when the user is reliably at home. Consequently, a higher priority is allocated to an individual so that the individual can easily receive the package.

Furthermore, the control unit may acquire information on the type of the package as the information on the package attribute, and may allocate a higher priority to the package when food is included in the package than when no food is included in the package. Moreover, the control unit may acquire information on the expiry date of the package as the information on the package attribute, and may allocate a higher priority to the package when the expiry date is short.

For example, if the expiry date of the food has passed because the food could not be delivered at the desired delivery time, value would be lost. Therefore, it is possible to prevent the food from losing value by allocating a higher priority to hasten the delivery. Moreover, in a case where the expiry date is designated for food, a higher priority may be allocated when the expiry date is short. Furthermore, food for which an expiry date or best before date is designated may be allocated a higher priority than food for which an expiry date is not designated. Accordingly, by making the delivery time close to the desired delivery time in accordance with the expiry date, it is possible to prevent food from losing value.

Furthermore, the control unit may allocate a higher priority to the package when the delivery destination of the package is far away from a predetermined point.

The predetermined point is a point at which the package can be easily delivered, for example, the center of a delivery area, or a point at which traffic congestion does not occur or lasts for a shorter time than other points. For example, if the delivery location is close to the center of the delivery area, it is easy to deliver the package along with other packages. Therefore, even if a lower priority is allocated to such a package, it is possible to prevent the package from not being delivered. On the other hand, if the delivery location is far away from the center of the delivery area, it is difficult to deliver the package since the person or object that is delivering the package must go to a desired delivery location that is far away just to deliver such a package. Therefore, by allocating a higher priority to a delivery location that is far away from the predetermined point, it is possible to prevent the package from not being delivered to such a delivery location.

Hereinafter, embodiments of the present disclosure will be described with reference to the drawings. Configurations of the following embodiments are merely an example, and the present disclosure is not limited to those configurations of the embodiments. Further, the following embodiments can be combined as much as possible.

### Embodiments

(Outline of Delivery System)

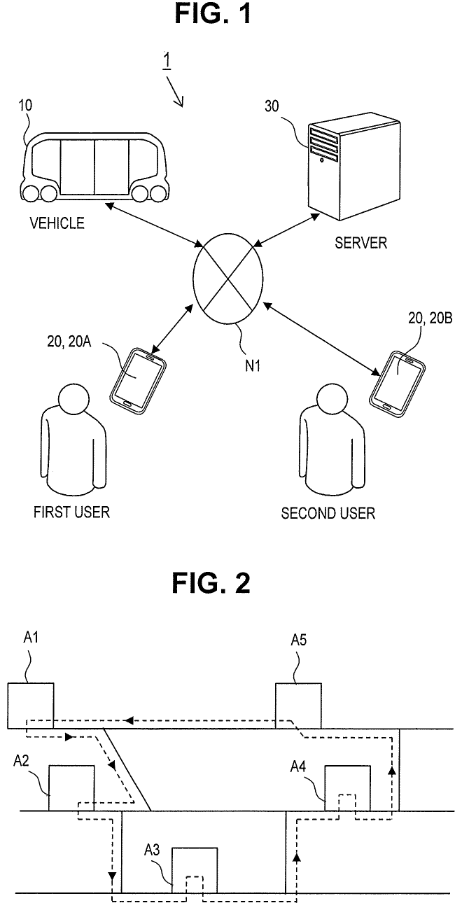

FIG. 1 is a diagram illustrating a schematic configuration example of a delivery system 1 according to an embodiment of the present disclosure. The delivery system 1 includes, for example, a vehicle 10, a user terminal 20, and a server 30. FIG. 1 shows two user terminals 20 (a first user terminal 20A and a second user terminal 20B) as an example. The vehicle 10, the first user terminal 20A, the second user terminal 20B, and the server 30 are connected to each other by a network N1. The network N1 may be, for example, a worldwide public communication network such as the Internet or the like, and a wide area network (WAN) or other communication network. The network N1 may include a telephone communication network such as a mobile phone or the like, and a wireless communication network such as Wi-Fi or the like. The number of vehicles 10 is not limited to one as illustrated in FIG. 1, and may be two or more. The vehicle 10 is a moving object that can autonomously travel based on an operation command generated by the server 30. The vehicle 10 is configured to be able to deliver packages. When several users (a first user and a second user in FIG. 1) request delivery of packages via the user terminal 20, the server 30 generates the operation command so that the vehicle 10 delivers, by autonomous travel, packages to each user using the delivery system 1 shown in FIG. 1. FIG. 1 illustrates a case where the first user requests the server 30 to deliver the package via the first user terminal 20A, and the second user requests the server 30 to deliver the package via the second user terminal 20B.

In addition to the first user and the second user, there can be more users who request delivery of the packages. Hereinafter, when the first user and the second user are not particularly distinguished, they are simply referred to as the “user”. Further, when the first user terminal 20A and the second user terminal 20B are not particularly distinguished, they are simply referred to as the “user terminal 20”. Hereinafter, the package delivered to the first user may be referred to as a first package, and the package delivered to the second user may be referred to as a second package. When the first package and the second package are not particularly distinguished, they are simply referred to as the “package”. Hereinafter, a location where the package is delivered to the first user may be referred to as a first delivery destination, and a location where the package is delivered to the second user may be referred to as a second delivery destination. When the first delivery destination and the second delivery destination are not particularly distinguished, they are simply referred to as the “delivery destination”. Conventional technologies may be used for loading the package on the vehicle 10 and unloading the package from the vehicle 10.

The server 30 generates the operation command for the vehicle 10 so that the vehicle 10 travels via the first delivery destination and the second delivery destination in order to deliver packages by the vehicle 10. The operation command generated by the server 30 is transmitted from the server 30 to the vehicle 10. The vehicle 10 that has received the operation command autonomously travels in accordance with the operation command. The operation command is generated so that a time when the vehicle 10 travels to each delivery destination is a time designated by the user (it may be a period of time or a specific time). The user may designate a specific time at which the package is desired to be delivered, or may designate a period of time having a certain range. In the following description, it is assumed that the user designates a time when delivery is desired (hereinafter also referred to as a “desired time”).

The server 30 sets the priority for the packages. In the present embodiment, it is assumed that the first package has a higher priority than the second package. The priority is a degree by which delivery of the package is prioritized so that the actual delivery time of the package is close to the desired time. The priority is set by the server 30 based on the user information and the package information. For example, a package delivered to an individual has a higher priority than a package delivered to a corporation or a store. This is because a problem is less likely to occur for a corporation or a store even when the delivery time is changed. For example, there are several people capable of receiving the package and several places where the package can be placed in a corporation or a store, thus the package is highly likely to be received even if the delivery time of the package deviates from the desired time. On the other hand, in a case where the package is delivered to an individual, the package is less likely to be received when the individual is absent. Therefore, if the delivery time of the package deviates from the desired time, it may be difficult to receive the package because the individual is absent. Consequently, by allocating a higher priority to the package addressed to an individual, it is possible to prevent the package addressed to an individual from not being delivered.

The server 30 also may change the priority in accordance with the type of the package. For example, when the package includes fresh food, a higher priority is allocated when the expiry date is short. In other words, it is desirable to deliver the package to the user faster when the expiry date is short, so that the user can easily receive the package due to the allocation of a higher priority. By way of another example, the priority of food or the like for which an expiry date is designated may be set to be higher than that of items without an expiry date, such as machines or the like. Moreover, the priority for a package delivered to a location where it is difficult to deliver within the delivery area may be set to be higher. If a designated location is a place where the package can be easily delivered, redelivery is easier even in a case where the user is absent when the package is delivered. It is also possible to deliver the package along with other packages at the same time. On the other hand, a higher priority is allocated to a location where the delivery is difficult (for example, a location where traffic congestion is likely to occur, or a location which is further away). For example, a higher priority may be allocated to a location that is far away from the center of the delivery area. Accordingly, it is possible to improve the efficiency of the package delivery by setting the priority of the package based on the user information and the package information.

The server 30 generates a travel route of the vehicle 10 so that the delivery time of the package with a higher priority is close to the desired time. Furthermore, the desired time can be changed by the user even after the server 30 has generated the operation command and the vehicle 10 has started to travel. For example, in a case in which the desired time is changed in accordance with a change in when the user is at home, a travel route different from the travel route set when the vehicle 10 started to travel is newly designated. In a case in which the package with a higher priority cannot be delivered at the desired time unless the delivery time of the package with a lower priority is adjusted, the delivery time of the package with a lower priority may deviate from the desired time. That is, in a case where the desired time for the package with a higher priority is changed, the actual delivery time of the package with a higher priority is close to, or matches with, the desired time, by adjusting the delivery time of the package with a lower priority.

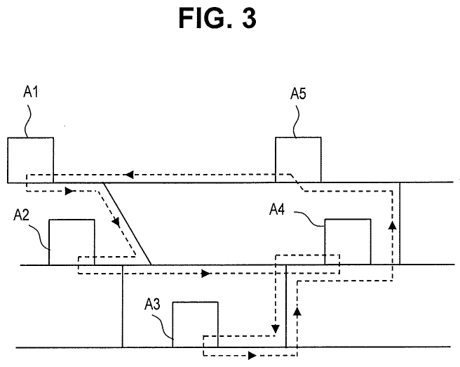

FIGS. 2 and 3 are diagrams respectively illustrating a travel route of the vehicle 10. A broken line shown in FIG. 2 indicates the travel route of the vehicle 10 generated when the vehicle 10 departs from A1. The travel route at this time is generated so that the vehicle 10 travels from a departure point A1, passes through transit points A2, A3, A4 and A5 in this order, and returns to the departure point A1. A4 is a location of the first user (first delivery destination), and A3 is a location of the second user (second delivery destination). The vehicle 10 is designated to travel in the order of A1, A2, A3, A4 and A5 when the vehicle 10 departs, whereby the package can be delivered to each transit point at the desired time.

On the other hand, a broken line shown in FIG. 3 indicates a case where the travel route of the vehicle 10 is changed while the vehicle 10 is traveling, when the first user wants to set an earlier desired time for the first package after the vehicle 10 has started to travel. In the example shown in FIG. 3, the first package cannot be delivered at the desired time if the vehicle 10 travels via the transit points A1, A2, A3, A4 and A5 in this order. In this case, the first package of the first user is delivered to A4 before the second package of the second user is delivered to A3, thus the delivery time of the first package matches with the desired time. After receiving information on the change of the desired time from the first user terminal 20A, the server 30 adjusts the delivery time of the second package to having a lower priority than the first package so that the second package is delivered later, and generates a renewed operation command for the vehicle 10, whereby the first package is delivered before the second package. The server 30 generates the operation command so that the vehicle 10 travels in the order of A1, A2, A4, A3, A5 and A1, and transmits the operation command to the vehicle 10. The vehicle 10 that has received the operation command changes the travel route in accordance with the operation command.

(Hardware Configuration)

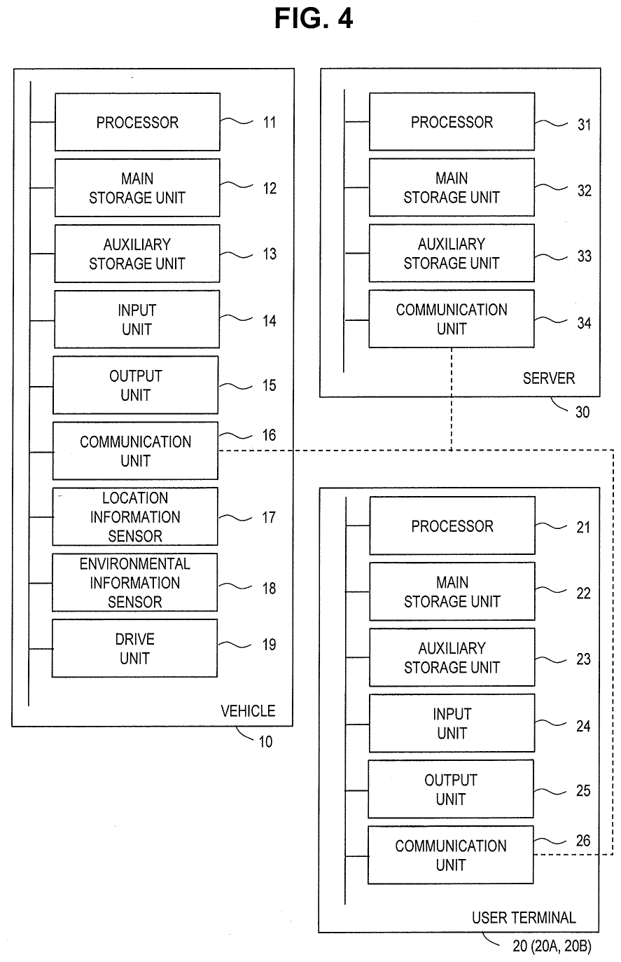

Referring to FIG. 4, hardware configurations of the vehicle 10, the first user terminal 20A, the second user terminal 20B, and the server 30 will be described. FIG. 4 is a block diagram schematically illustrating each exemplified configuration of the vehicle 10, the first user terminal 20A, the second user terminal 20B, and the server 30, which constitute the delivery system 1 according to the present embodiment.

The server 30 is configured by a general computer. The server 30 includes a processor 31, a main storage unit 32, an auxiliary storage unit 33, and a communication unit 34. These components are connected to each other by a bus. The server 30 is one example of the information processing apparatus.

The processor 31 is a central processing unit (CPU), a digital signal processor (DSP), or the like. The processor 31 controls the server 30 and performs various information processing calculations. The processor 31 is one example of the “control unit”. The main storage unit 32 is a random access memory (RAM), a read only memory (ROM), or the like. The auxiliary storage unit 33 is an erasable programmable ROM (EPROM), a hard disk drive (HDD), a removable medium, or the like. The auxiliary storage unit 33 stores an operating system (OS), various programs, various tables, and the like. The processor 31 loads the program stored in the auxiliary storage unit 33 into a working area of the main storage unit 32 and executes such a program. Each component is controlled by executing the program. Consequently, the server 30 implements a function that matches a predetermined purpose. The main storage unit 32 and the auxiliary storage unit 33 are computer-readable recording media. Furthermore, the server 30 may be a single computer or a combination of computers. The information stored in the auxiliary storage unit 33 may be stored in the main storage unit 32. Additionally, the information stored in the main storage unit 32 may be stored in the auxiliary storage unit 33.

The communication unit 34 is configured to communicate with the vehicle 10, the first user terminal 20A, and the second user terminal 20B via the network N1. The communication unit 34 is, for example, a local area network (LAN) interface board or a wireless communication circuit for wireless communication. The LAN interface board and the wireless communication circuit are connected to the network N1.

A series of processes executed by the server 30 can be executed by hardware, but can also be executed by software. The hardware configuration of the server 30 is not limited to that shown in FIG. 4. Furthermore, part or all of the configuration of the server 30 may be installed in the vehicle 10.

The vehicle 10 will be described hereinbelow. The vehicle 10 includes a processor 11, a main storage unit 12, an auxiliary storage unit 13, an input unit 14, an output unit 15, a communication unit 16, a location information sensor 17, an environmental information sensor 18, and a drive unit 19. These components are connected to each other by a bus. The processor 11, the main storage unit 12 and the auxiliary storage unit 13 are the same as the processor 31, the main storage unit 32 and the auxiliary storage unit 33 of the server 30, thus descriptions will be omitted.

The input unit 14 is configured to receive an input operation performed by the user, and is, for example, a touchscreen, a push button, or the like. The output unit 15 is configured to present information to the user, and is, for example, a liquid crystal display (LCD), an electroluminescence (EL) panel, a speaker, a lamp, or the like. The input unit 14 and the output unit 15 may be configured as a single touchscreen display. The communication unit 16 is configured to allow the self-driving vehicle 10 to access the network N1. The communication unit 16 is a circuit for performing a communication with other devices (for example, the server 30) via the network N1 using, for example, a mobile communication service (telephone communication network such as third generation (3G) or long-term evolution (LTE), and wireless communication such as Wi-Fi).

The location information sensor 17 acquires location information (for example, latitude and longitude) of the vehicle 10 at a predetermined cycle. The location information sensor 17 may be, for example, a global positioning system (GPS) receiver, a Wi-Fi communication unit, or the like. The information acquired by the location information sensor 17 is recorded in, for example, the auxiliary storage unit 13 and transmitted to the server 30.

The environmental information sensor 18 is configured to monitor a state of the vehicle 10 or to monitor the periphery of the vehicle 10. Examples of the sensor for monitoring the state of the vehicle 10 include an acceleration sensor, a speed sensor, and an azimuth angle sensor. Examples of the sensor for monitoring the periphery of the vehicle 10 include a stereo camera, a laser scanner, a LIDAR, and a radar.

The drive unit 19 allows the vehicle 10 to travel based on a control command generated by the processor 11. The drive unit 19 includes, for example, a motor, an inverter, a brake, a steering mechanism, and the like, for driving wheels included in the vehicle 10. The autonomous travel of the vehicle 10 is implemented by driving the motor, the brake or the like in accordance with the control command.

The user terminal 20 will be described hereinbelow. The user terminal 20 is, for example, a small computer such as a smartphone, a mobile phone, a tablet terminal, a personal information terminal, a wearable computer (such as a smart watch), or a personal computer (PC). The user terminal 20 includes a processor 21, a main storage unit 22, an auxiliary storage unit 23, an input unit 24, an output unit 25, and a communication unit 26. These components are connected to each other by a bus. The processor 21, the main storage unit 22, the auxiliary storage unit 23, the input unit 24, the output unit 25, and the communication unit 26 are the same as the processor 11, the main storage unit 12, the auxiliary storage unit 13, the input unit 14, the output unit 15, and the communication unit 16 of the vehicle 10, thus descriptions will be omitted. Furthermore, the user terminal 20 may be a single computer or a combination of computers.

(Functional Configuration: Server)

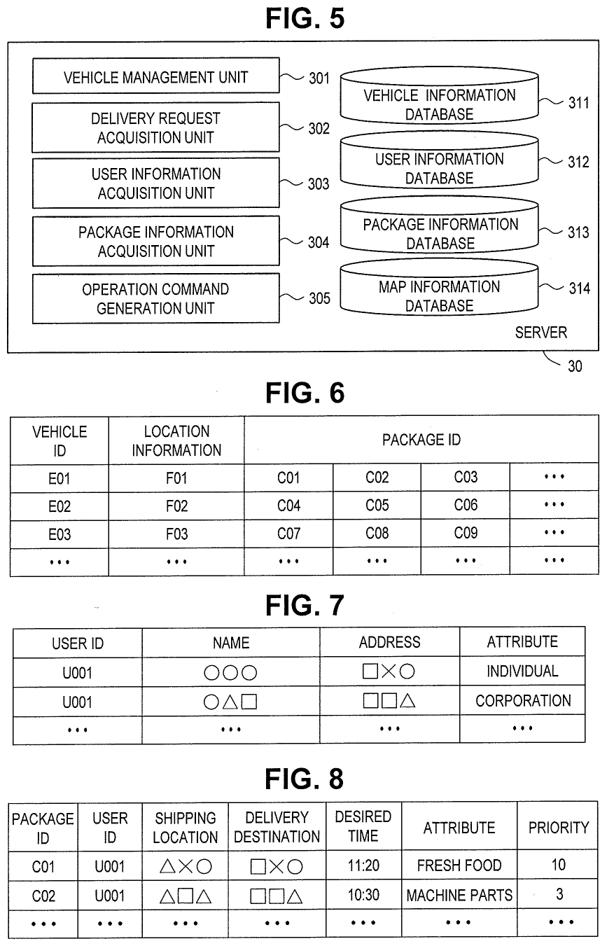

FIG. 5 is a diagram illustrating one example of a functional configuration of the server 30. The server 30 includes a vehicle management unit 301, a delivery request acquisition unit 302, a user information acquisition unit 303, a package information acquisition unit 304, an operation command generation unit 305, a vehicle information database 311, a user information database 312, a package information database 313, and a map information database 314 as functional components. For example, the vehicle management unit 301, the delivery request acquisition unit 302, the user information acquisition unit 303, the package information acquisition unit 304, and the operation command generation unit 305 are the functional components implemented by executing various programs stored in the auxiliary storage unit 33 by the processor 31 of the server 30.

The vehicle information database 311, the user information database 312, the package information database 313, and the map information database 314 respectively are, for example, a relational database constructed by managing data stored in the auxiliary storage unit 33 by a database management system (DBMS) program executed by the processor 31. Any one of the functional components of the server 30 or a part of the processing may be executed by another computer connected to the network N1.

The vehicle management unit 301 manages various information related to the vehicle 10. For example, the vehicle management unit 301 acquires and manages the location information transmitted from the vehicle 10 in a predetermined cycle or the location information transmitted from the vehicle 10 in response to a request from the server 30. The vehicle management unit 301 stores the location information in association with a vehicle ID in the vehicle information database 311. The vehicle ID is an identifier unique to the vehicle 10. In addition, the vehicle management unit 301 manages, for example, the package information on the package delivered by the vehicle 10. The area where the vehicle 10 delivers the package is assigned in advance for each vehicle 10, and the vehicle management unit 301 allocates packages to each vehicle 10 in accordance with the delivery destination of the packages.

The delivery request acquisition unit 302 acquires, for example, a delivery request from the user terminal 20 of the user who wants to receive a package. The delivery request refers to information including a user identifier, and refers to information for requesting delivery of the user's package. Furthermore, the delivery request acquisition unit 302 acquires a change request from the user terminal 20 of the user who wants to change the desired time for the package. The change request refers to information including a package identifier, and is information for requesting a change of the desired time for the package. The change request includes information indicating the desired time that has been changed.

The user information acquisition unit 303 acquires, for example, information on the user corresponding to each user terminal 20 (user information). The user information includes, for example, information associated with the user, such as user ID, name, address, user attribute, and the like. The user ID is an identifier unique to the user. The information on user attribute is information on the user and is useful when setting the priority of the package to be received by the user. The information on the user attribute is information indicating, for example, whether the user is an individual, a corporation or a store. The user information is transmitted from the user terminal 20 to the server 30 and registered in the server 30. When acquiring the user information, the user information acquisition unit 303 stores the user information in the user information database 312 described later.

The package information acquisition unit 304 acquires information on the package (hereinafter also referred to as “package information”). The package information includes information transmitted from the user terminal 20 to the server 30 together with the delivery request, and also includes information on the package attribute, information on a shipping location of the package, information on the delivery destination, information on the desired time, and information on the priority of the package. The information on the package attribute is information useful for setting the priority of the package. The package attribute is, for example, information indicating whether the package is an item with an expiry date (for example, fresh food) or an item without an expiry date (for example, a machine). Further, the package attribute can include information indicating the expiry date.

The package information acquisition unit 304 sets the priority of the package. The priority is, for example, set in accordance with at least one of the information on the package attribute, information on the user attribute, and information on the delivery destination. For example, when the package contains fresh food, a higher priority is allocated than when the package contains machine parts. Furthermore, when the user is an individual, a higher priority is allocated than when the user is a corporation or a store. Moreover, a higher priority is allocated to a delivery destination that is far away from the center of a delivery area. The priority is set to be higher for a case in which the user cannot easily receive the package. For example, a score is determined in advance for each of the package attribute, the user attribute, and the delivery destination, and the priority is calculated by adding the score. The scores corresponding to the package attribute, the user attribute, and the delivery destination are stored in advance in the auxiliary storage unit 33. When acquiring the package information, the package information acquisition unit 304 stores the package information in the package information database 313 described later.

The operation command generation unit 305 generates, for example, a operation command so that the vehicle 10 departs from and returns to the departure point via the delivery destination of the package. The operation command generation unit 305 generates a travel route based on map information stored in the map information database 314 described later. The travel route is generated so that, for example, a travel time is calculated from the speed of the vehicle 10 between the delivery destinations and a travel distance of the vehicle 10, and each package can be delivered at a time close to the desired time of each package. In terms of the speed of the vehicle 10, for example, a speed designated for each road or the average speed when the vehicle 10 previously traveled on each road is used. The operation command generation unit 305 generates the travel route so that a difference between the actual delivery time of the package with a higher priority and the desired time for the package is decreased. The operation command generation unit 305 generates the travel route, and transmits the operation command including the travel route to the vehicle 10. Furthermore, when receiving the change request from the user terminal 20, the operation command generation unit 305 generates the renewed operation command so as to change the delivery time of the package that is related to the change request. At this time, in a case in which it is necessary to change the delivery time of other packages, the delivery time of the package that is related to the change request is matched to the changed desired time, by altering the delivery time of a package with a lower priority than the package that is related to the change request.

The vehicle information database 311 is constructed by storing the vehicle information in the auxiliary storage unit 33, in which the vehicle ID is associated with the vehicle information. A structure of the vehicle information stored in the vehicle information database 311 will be described referring to FIG. 6. FIG. 6 is a diagram illustrating a table configuration of the vehicle information. A vehicle information table has fields for vehicle ID, location information, and package ID. Identification information for identifying the vehicle 10 (information indicating the vehicle ID) is input to the vehicle ID field. Location information transmitted from the vehicle 10 is input to the location information field. The location information is information indicating a current location of the vehicle 10. Identification information for identifying the package loaded on the vehicle 10 (information indicating the package ID) is input to the package ID field. The package ID is an identifier unique to the package.

The user information database 312 is constructed by storing the user information in the auxiliary storage unit 33, in which the user ID is associated with the user information. A structure of the user information stored in the user information database 312 will be described referring to FIG. 7. FIG. 7 is a diagram illustrating a table configuration of the user information. A user information table has fields for user ID, name, address, and attribute. Identification information for identifying the user is input to the user ID field. Information indicating the name of the user is input in the name field. Information indicating the address of the user is input in the address field. The user's address may be used as the delivery destination of the package. Information on the user attribute is input in the attribute field. For example, information on a type of individual or corporation is input to the attribute field.

The package information database 313 is constructed by storing the package information in the auxiliary storage unit 33, in which the package ID is associated with the package information. A structure of the package information stored in the package information database 313 will be described referring to FIG. 8. FIG. 8 is a diagram illustrating a table configuration of the package information. A package information table has fields for package ID, user ID, shipping location, delivery destination, desired time, attribute, and priority. Identification information for identifying the package is input to the package ID field. Identification information for identifying the user receiving the package is input to the user ID field. Information indicating the delivery destination as a delivery destination of the package is input to the delivery destination field. The delivery destination of the package is, for example, the user's address. Information indicating the time when the user wants to receive the package is input to the desired time field. Information on the package attribute is input in the attribute field. Information on the priority of the package calculated by the package information acquisition unit 304 is input to the priority field. In a case in which the server 30 receives the change request from the user terminal 20, the desired time of the corresponding package is updated.

The map information database 314 stores map data and map information including point of interest (POI) information such as characters and photographs indicating characteristics of each point on the map data. The map information database 314 may be provided from another system connected to the network N1, for example, a geographic information system (GIS).

(Functional Configuration: Vehicle)

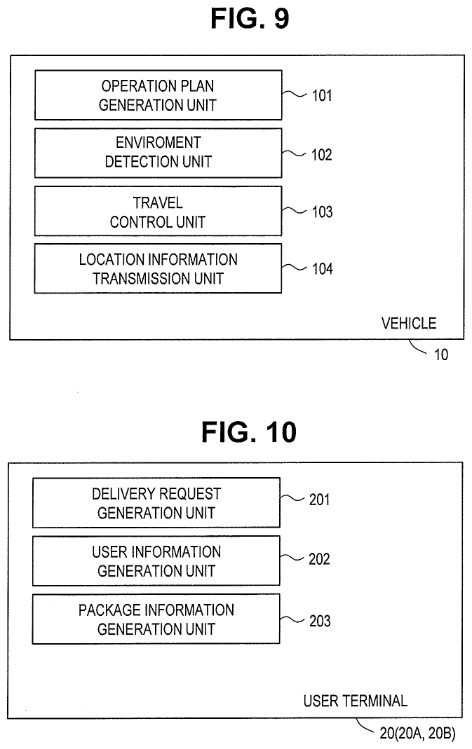

FIG. 9 is a diagram illustrating one example of a functional configuration of the vehicle 10. The vehicle 10 includes an operation plan generation unit 101, an environment detection unit 102, a travel control unit 103, and a location information transmission unit 104 as functional components. For example, the operation plan generation unit 101, the environment detection unit 102, the travel control unit 103, and the location information transmission unit 104 are the functional components implemented by executing various programs stored in the auxiliary storage unit 13 by the processor 11 of the vehicle 10.

The operation plan generation unit 101 acquires the operation command from the server 30 and generates an operation plan of the vehicle 10. The operation command includes information on transit points through which the vehicle 10 travels. The operation plan generation unit 101 calculates the travel route of the vehicle 10 and generates the operation plan for moving along the travel route, based on the operation command transmitted from the server 30.

The environment detection unit 102 detects the environment around the vehicle 10 required for autonomous travel based on the data acquired by the environmental information sensor 18. Detection targets include, for example, but are not limited to, the number and positions of lanes, the number and positions of other moving objects existing around the vehicle 10, the number and positions of obstacles (for example, pedestrians, bicycles, structures, buildings, and the like) existing around the vehicle 10, road structures, road signs, and the like. Any detection target may be used as long as it is necessary for autonomous traveling. In a case where the environmental information sensor 18 is, for example, a stereo camera, object detection is performed around the vehicle 10 by performing image processing on image data captured by the environmental information sensor 18. Data relating to the environment around the vehicle 10 (hereinafter referred to as “environment data”) detected by the environment detection unit 102 is sent to the travel control unit 103.

The travel control unit 103 generates a control command for controlling the autonomous travel of the vehicle 10, based on the operation plan generated by the operation plan generation unit 101, the environment data generated by environment detection unit 102, and the location information of the vehicle 10 acquired by the location information sensor 17. For example, the travel control unit 103 generates the control command for the vehicle 10 directed to travel along a predetermined route such that an obstacle does not enter a predetermined safety area centered around the vehicle 10. The generated control command is transmitted to the drive unit 19. A well-known method can be adopted as a method for generating a control command to allow the vehicle 10 to autonomously travel.

The location information transmission unit 104 transmits the location information acquired from the location information sensor 17 to the server 30 via the communication unit 16. The timing at which the location information transmission unit 104 transmits the location information can be set as appropriate. For example, the location information transmission unit 104 may transmit the location information periodically, may transmit some information in accordance with the set timing to transmit to the server 30, or may transmit in response to a request from the server 30. The location information transmission unit 104 transmits the location information to the server 30 together with the identification information (vehicle ID) that uniquely identifies a host vehicle. The vehicle ID for identifying the vehicle 10 is assigned in advance.

(Functional Configuration: User Terminal)

Functions of the user terminal 20 will be described hereinbelow. FIG. 10 is a diagram illustrating a functional configuration of the user terminal 20. The user terminal 20 includes a delivery request generation unit 201, a user information generation unit 202, and a package information generation unit 203 as functional components. For example, the delivery request generation unit 201, the user information generation unit 202, the package information generation unit 203 are the functional components implemented by executing various programs stored in the auxiliary storage unit 23 by the processor 21 of the user terminal 20. However, any one of the functional components or a part of the processing may be executed by a hardware circuit.

The delivery request generation unit 201 displays an operation screen on the output unit 25 and generates a delivery request in response to an input, to the input unit 24, by the user. For example, the delivery request generation unit 201 outputs an icon or the like for generating a delivery request on a touchscreen display, and generates the delivery request when the user clicks the icon. The delivery request generation unit 201 transmits the generated delivery request to the server 30 in association with the user ID. Further, the delivery request generation unit 201 displays the operation screen on the output unit 25 and generates a change request in response to an input, to the input unit 24, by the user. For example, the delivery request generation unit 201 outputs a screen that prompts the user to change the desired time on the touchscreen display, and generates the change request when the user inputs the desired time on the screen. The delivery request generation unit 201 transmits the generated change request to the server 30 in association with the user ID.

The user information generation unit 202 generates the user information. The user information generation unit 202 displays an operation screen that prompts input of user information (for example, name, address, and attribute) on the output unit 25, and generates the user information in response to the input, to the input unit 24, by the user. The generated user information is transmitted to the server 30 by the user information generation unit 202 in association with the user ID. Moreover, the user information may be input by the user in advance using the input unit 24 and stored in the auxiliary storage unit 23 of the user terminal 20. The user information generation unit 202 may generate the user information based on the data stored in the auxiliary storage unit 23. Furthermore, the user information generation unit 202 may generate and transmit the user information to the server 30, for example, when each user performs user registration. In this case, the user information is stored in advance in the user information database 312 of the server 30.

The package information generation unit 203 generates a part of the package information. The package information generation unit 203 displays an operation screen that prompts input of the package information (for example, package attribute, shipping location, delivery destination and desired time) on the output unit 25, and generates the package information in response to the input, to the input unit 24, by the user. The delivery request generation unit 201 transmits the generated package information to the server 30 together with the delivery request. Moreover, the package information transmitted from the user terminal 20, to the server 30, may be previously input by the user using the input unit 24 and stored in the auxiliary storage unit 23 of the user terminal 20. Then, the package information generation unit 203 may generate the package information based on the data stored in the auxiliary storage unit 23.

Even after the delivery request is transmitted to the server 30, the user can change the desired time. In a case where the user changes the desired time via the input unit 24, the package information generation unit 203 generates a part of the package information again. The delivery request generation unit 201 transmits the thus generated package information to the server 30 together with the change request.

(Flow of Processing: System)

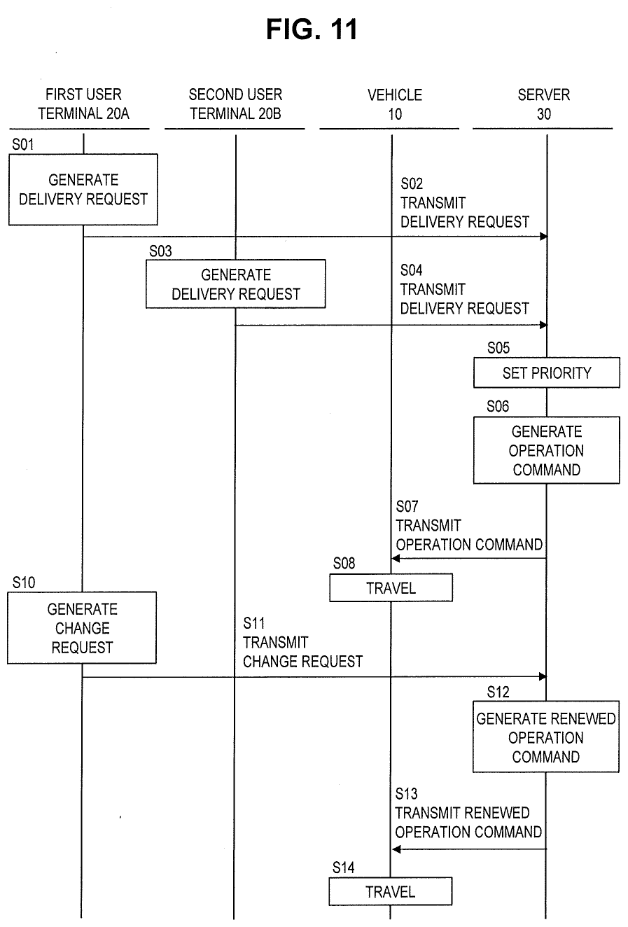

An operation of the delivery system 1 will be described hereinbelow. FIG. 11 is a diagram illustrating a processing sequence of the delivery system 1. In the sequence diagram shown in FIG. 11, it is assumed that the first user and the second user want to receive packages. In addition, the user information is transmitted in advance from each user terminal 20, and the location information of the vehicle 10 is transmitted to the server 30 at predetermined intervals.

First, when the first user inputs to the first user terminal 20A that the first user wants to receive the package and the package information, the first user terminal 20A generates the delivery request and the package information, respectively (processing of S01). The delivery request and the package information are transmitted from the first user terminal 20A to the server 30 (processing of S02). Similarly, when the second user inputs to the second user terminal 20B that the second user wants to receive the package and the package information, the second user terminal 20B generates the delivery request and the package information, respectively (processing of S03). The delivery request and the package information are transmitted from the second user terminal 20B to the server 30 (processing of S04). The server 30 sets the priority corresponding to each package (processing of S05) and stores the priority in the package information database 313.

The server 30 generates the operation command at a predetermined time (processing of S06). In S06, the server 30 executes an operation command generation process described later. The server 30 generates the operation command, and then transmits the operation command to the vehicle 10 (processing of S07). The vehicle 10 that has received the operation command travels in accordance with the operation command (processing of S08).

In FIG. 11, after the vehicle 10 starts to travel in S08, the first user changes the desired time. When the first user inputs the changed desired time to the first user terminal 20A, the first user terminal 20A generates the change request (processing of S10). The change request is transmitted from the first user terminal 20A to the server 30 (processing of S11). When receiving the change request, the server 30 executes a renewed operation command generation process described later (processing of S12). The server 30 generates the renewed operation command, and then transmits the operation command to the vehicle 10 (processing of S13). The vehicle 10 that has received the renewed operation command travels in accordance with the renewed operation command (processing of S14). In addition, when the server 30 transmits the operation command to the vehicle 10, the second user terminal 20B may be transmitted with information about a delayed delivery of the package.

(Flow of Processing: Server)

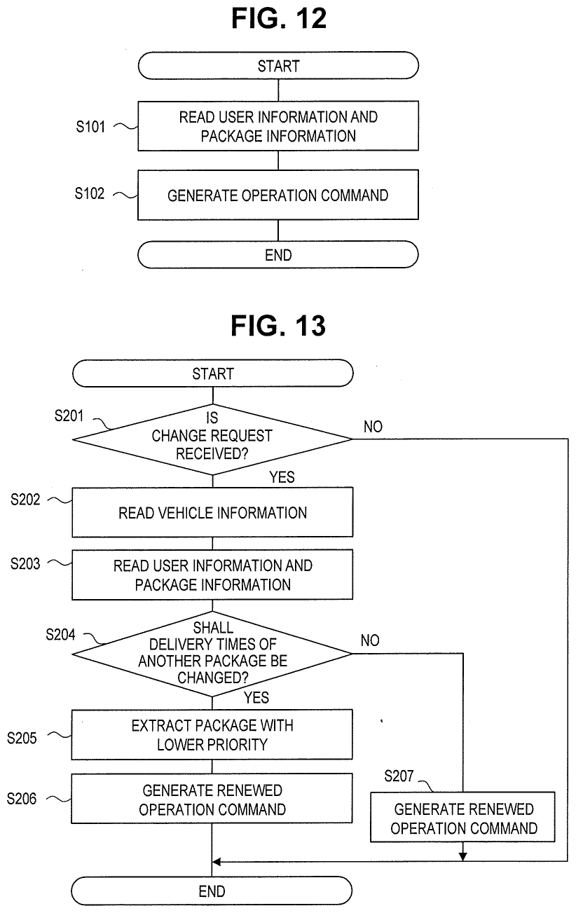

The operation command generation process executed in S06 of the sequence diagram shown in FIG. 11 will be described hereinbelow. FIG. 12 is an exemplified flowchart illustrating the operation command generation process according to the present embodiment. The process illustrated in FIG. 12 is executed at predetermined intervals by the operation command generation unit 305 of the server 30. It is assumed herein that the server 30 has already received information necessary for constructing the vehicle information database 311, the user information database 312 and the package information database 313 from the vehicle 10, the first user terminal 20A, and the second user terminal 20B.

In step S101, the user information is read from the user information database 312 and the package information is read from the package information database 313. In step S102, the operation command for the vehicle 10 is generated. The operation command generation unit 305 generates the travel route of the vehicle 10 so that the vehicle 10 can deliver each package at the desired time based on the delivery destination and the desired time of the package, which have been read in step S101. At this time, priority may be given to the desired time of the package with a higher priority. Thereafter, the operation command generation unit 305 transmits the generated operation command to the vehicle 10.

The renewed operation command generation processing executed in S12 of the sequence diagram shown in FIG. 11 will be described hereinbelow. FIG. 13 is an exemplified flowchart illustrating the renewed operation command generation process according to the present embodiment. The process illustrated in FIG. 13 is executed at predetermined intervals by the operation command generation unit 305 of the server 30. It is assumed herein that the server 30 has already received information necessary for constructing the vehicle information database 311, the user information database 312 and the package information database 313 from the vehicle 10, the first user terminal 20A, and the second user terminal 20B.

In step S201, it is determined whether the change request has been received or not. If a positive determination is made in step S201, the processing proceeds to step S202. If a negative determination is made, this routine is terminated. In step S202, the vehicle information is read from the vehicle information database 311. Since the vehicle 10 has already departed, the location information of the vehicle 10 is acquired in step S202. In step S203, the user information is read from the user information database 312 and the package information is read from the package information database 313.

In step S204, it is determined whether or not it is necessary to alter the delivery time of other packages in order to deliver the package related to the change request at the desired time. In other words, it is determined whether or not the package related to the change request cannot be delivered at the desired time unless the delivery time of another package is changed. The operation command generation unit 305 determines whether or not the package related to the change request can be delivered at the desired time based on the delivery destination and the desired time of a package delivered immediately before the package related to the change request (hereinafter also referred to as “previous package”). Moreover, the operation command generation unit 305 determines, based on the delivery destination and the desired time of a package delivered immediately after the package related to the change request (hereinafter also referred to as “later package”), whether or not the later package can be delivered at the desired time after the package related to the change request is delivered. A negative determination is made in step S204 when the package related to the change request and the later package can be delivered at their respective desired times. In this case, the processing proceeds to step S207 to change only the delivery time of the package related to the change request and generate the renewed operation command. Thereafter, the operation command generation unit 305 transmits the generated operation command to the vehicle 10.

On the other hand, if a positive determination is made in step S204, it is necessary to change the delivery time of another package than the package related to the change request. Therefore, in step S205, a package with a lower priority than the package related to the change request is extracted. Undelivered packages will be candidates for the extraction. The operation command generation unit 305 picks up undelivered packages based on the location information of the vehicle 10. In step S206, the renewed operation command is generated in accordance with the priority of each package. The operation command generation unit 305 generates the travel route of the vehicle 10 so that the vehicle 10 can deliver each package at the desired time based on the location information of the vehicle 10, which has been read in S202, and the delivery destination and the desired time of the package, which have been read in step S203. At this time, priority is given to the desired time of the package with a higher priority, and the delivery time of the package extracted in step S205 is changed. Thereafter, the operation command generation unit 305 transmits the generated operation command to the vehicle 10.

As stated above, according to the present embodiment, when the package is delivered using the vehicle 10 that autonomously travels, the delivery time can be adjusted based on the priority of the package. Accordingly, since delivery of a package with a higher priority, for example, a package addressed to an individual, is given priority, it is possible to deliver packages with high accuracy at the desired time. Therefore, since an individual can receive packages on time, it is possible to reduce the waiting time until the package arrives and also possible to receive the package more reliably. Consequently, the costs incurred due to redelivery of the package can be reduced.

### OTHER EMBODIMENTS

The embodiments stated above are mere examples, and the present disclosure can be implemented with appropriate modifications within a scope not departing from the gist thereof.

The processing and units described in the present disclosure can be freely combined and implemented unless technical contradiction occurs.

Furthermore, the processing described as being performed by a single device may be executed in a shared manner by a plurality of devices. Alternatively, the processing described as being performed by different devices may be executed by a single device. In the computer system, the hardware configuration (server configuration) for implementing each function can be flexibly changed. In the embodiment stated above, the server 30 is described as one example of the information processing apparatus. However, the present disclosure is not limited thereto, and a terminal installed in the vehicle 10 may function as the information processing apparatus, or the user terminal 20 may function as the information processing apparatus. Furthermore, the server 30, and the terminal installed in the vehicle 10 or the user terminal 20 may function as the information processing apparatus. For example, in the embodiment stated above, the server 30 includes a vehicle management unit 301, a delivery request acquisition unit 302, a user information acquisition unit 303, a package information acquisition unit 304, an operation command generation unit 305, a vehicle information database 311, a user information database 312, a package information database 313, and a map information database 314 as functional components; however, a part or all of these functional components may be included in the vehicle 10.

The present disclosure can also be implemented by supplying a computer program for executing the functions, described in the embodiments, in a computer, and reading and executing the program by one or more processors included in the computer. Such a computer program may be provided to the computer by a non-transitory computer-readable storage medium connectable to a computer system bus, or may be provided to the computer via the network. Examples of the non-transitory computer-readable storage media include random disk (such as a magnetic disk (Floppy® disk, hard disk drive (HDD), and the like) or optical disc (CD-ROM, DVD disc, Blu-ray disc, and the like)), read-only memory (ROM), random access memory (RAM), EPROM, EEPROM, magnetic card, flash memory, optical card, and a random type of medium suitable for storing electronic instructions.

What is claimed is:

1. An information processing apparatus that controls a moving object that delivers a package by autonomous travel, the information processing apparatus comprising:
a control unit configured to execute:
generating an operation command for the moving object based on a delivery destination and a desired delivery time of the package;
setting a priority of the package, based on information on a user receiving the package or information on the package; and
in a case where the desired delivery time of a first package among a plurality of packages is changed while the moving object is traveling based on the operation command, with the plurality of packages loaded, when it is not possible to deliver the first package at the changed desired delivery time unless a delivery time of another package than the first package is changed, changing the delivery time of a second package among the plurality of packages, and generating a renewed operation command such that the delivery time of the first package becomes closer to the changed desired delivery time, the second package having a lower priority than the first package.

2. The information processing apparatus according to claim 1, wherein the information on the user receiving the package is information on an attribute of the user receiving the package.

3. The information processing apparatus according to claim 1, wherein the information on the package is information on the delivery destination of the package, or information on an attribute of the package.

4. The information processing apparatus according to claim 2, wherein the control unit is configured to acquire information indicating whether the user is an individual or a corporation as the information on the attribute of the user receiving the package, and to allocate a higher priority to the package when the user is the individual than when the user is the corporation.

5. The information processing apparatus according to claim 3, wherein the control unit is configured to acquire information on a kind of the package as the information on the attribute of the package, and to allocate a higher priority to the package when food is included in the package than when no food is included.

6. The information processing apparatus according to claim 3, wherein the control unit is configured to acquire information on an expiry date of the package as the information on the attribute of the package, and to allocate a higher priority to the package as the expiry date is shorter.

7. The information processing apparatus according to claim 3, wherein the control unit is configured to allocate a higher priority to the package as the delivery destination of the package is farther away from a predetermined point.

8. An information processing method of controlling a moving object that delivers a package by autonomous travel, which is executed by a computer, the information processing method comprising:
generating an operation command for the moving object based on a delivery destination and a desired delivery time of the package;
setting a priority of the package, based on information on a user receiving the package or information on the package; and
in a case where the desired delivery time of a first package among a plurality of packages is changed while the moving object is traveling based on the operation command, with the plurality of packages loaded, when it is not possible to deliver the first package at the changed desired delivery time unless a delivery time of another package than the first package is changed, changing the delivery time of a second package among the plurality of packages, and generating a renewed operation command so that the delivery time of the first package becomes closer to the changed desired delivery time, the second package having a lower priority than the first package.

9. A program that controls a moving object that delivers a package by autonomous travel, the program causing a computer to execute:
generating a operation command for the moving object based on a delivery destination and a desired delivery time of the package;
setting a priority of the package, based on information on a user receiving the package and information on the package; and
in a case where the desired delivery time of a first package among a plurality of packages is changed while the moving object is traveling based on the operation command, with the plurality of packages loaded, when it is not possible to deliver the first package at the changed desired delivery time unless a delivery time of another package than the first package is changed, changing the delivery time of a second package among the plurality of packages, and generating a renewed operation command so that the delivery time of the first package becomes closer to the changed desired delivery time, the second package having a lower priority than the first package.
